(19) United States
(12) Patent Application Publication
(10) Pub. No.: US 2023/0165747 A1
(43) Pub. Date: Jun. 1, 2023

(54) UTERINE MASSAGE BELT

(71) Applicant: Davol Inc., Warwick, RI (US)

(72) Inventors: Maleeha Mashiatulla, Glen Ellyn, IL (US); Amelia Smith, Rochester, MI (US); Melanie Strimas, Mundelein, IL (US); Scott Andras, Little Elm, TX (US)

(21) Appl. No.: 17/539,297

(22) Filed: Dec. 1, 2021

(51) Int. Cl. A61H 15/00; A61J 1/10; A61H 21/00; A61H 9/00

(52) U.S. Cl. CPC A61H 15/00; A61J 1/10; A61H 21/00; A61H 9/0078; A61H 2015/0021; A61H 2201/0103; A61H 2205/087; A61H 2201/165; A61H 2201/1628; A61H 2201/0157

(57) ABSTRACT

Uterine massage belts and related methods are generally described. In some embodiments, a massage belt may be configured to compress a uterus between two force-applying components to induce uterine contraction and reduce the risk of postpartum hemorrhage. The belt may include at least one roller configured to push at least a portion of the uterus (e.g., the uterine fundus) in an inferior direction. The belt may be used with at least one inflatable body to push at least a portion of the uterus in a superior direction. The uterus positioned between the opposing forces may be urged to contract and increase its muscle tone to avoid severe postpartum complications. In some embodiments, the inflatable body may be part of the belt and may be positioned proximal to the pubic bone of the patient. In other embodiments, the inflatable body may be separate from the belt and positioned inside the vagina.

### FIELD

Disclosed embodiments are related to massage belts and related methods of use. More specifically, methods and apparatuses related to massage belts for uterine massage are disclosed.

### BACKGROUND

Postpartum hemorrhage is one of the top five causes of maternal mortality worldwide. The most common cause of postpartum hemorrhaging is uterine atony (otherwise known as an atonic uterus), wherein the uterus fails to contract properly following delivery. Proper uterine contraction typically closes off blood vessels that were previously used to supply the placenta, helping to prevent hemorrhage and facilitating blood coagulation. An atonic uterus, or a uterus which lacks sufficient muscle tone to contract, can therefore result in undesirable blood loss, which may be fatal for the mother. Obesity is a known risk factor of uterine atony.

### SUMMARY

In some aspects, uterine massage belts are provided. In some embodiments, a uterine massage belt includes a band including a central portion, at least one roller configured to be positioned on a first portion of the central portion of the band, and at least one inflatable bladder configured to be positioned on a second portion of the central portion of the band, wherein the at least one roller and the at least one inflatable bladder are configured to compress at least a portion of a uterus of a patient between the at least one roller and the at least one inflatable bladder to induce uterine contraction.

In some aspects, systems for uterine massage are provided. In some embodiments, a system for uterine massage includes a band including a central portion, at least one roller disposed on the central portion of the band, and an inflatable vaginal balloon configured to be inserted into a vagina of a patient, wherein the at least one roller is configured to apply a first force toward the inflatable vaginal balloon, and wherein the inflatable vaginal balloon is configured to apply a second force toward the at least one roller.

In some aspects, methods of providing uterine massage are provided. In some embodiments, a method of providing uterine massage includes actuating at least one roller to apply a first force toward a uterus of a patient, wherein the first force, inflating at least one bladder to apply a second force toward the uterus of the patient, and compressing at least a portion of the uterus in between the at least one roller and the at least one bladder during actuation of the at least one roller to induce uterine contraction.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 schematically illustrates a massage belt according to some embodiments;

FIG. 2 schematically illustrates the massage belt of FIG. 1 installed on a patient, according to some embodiments;

FIG. 3 schematically illustrates a massage belt according to other embodiments;

FIG. 4 schematically illustrates a side view of a massage belt according to some embodiments; and

FIG. 5 schematically illustrate a massage belt according to other embodiments.

### DETAILED DESCRIPTION

Conventional treatment for an atonic uterus involves a uterine massage (sometimes referred to as a fundal massage), wherein a clinician gently induces muscle contraction in the patient to reduce the risk of postpartum hemorrhaging. The uterine massage is performed by applying pressure to the pubic bone and firmly massaging the uterine fundus (upper portion of the uterus), encouraging the contraction process.

In a conventional uterine massage, a clinician places one hand near the fundal portion of the patient's uterus (e.g., on an upper portion of the patient's abdomen), pushing downward towards the vagina. The clinician then places their other hand on the lower portion of the patient's abdomen, near the lower portion of the patient's uterus, pressing upward and away from the vagina. The first hand applies pressure in a generally inferior direction towards the patient's head, and the second hand applies pressure in a generally superior direction towards the patient's feet, such that the uterus is compressed in between the clinician's hands, which can encourage uterine contraction. In instances where the lower portion of the patient's abdomen is generally inaccessible to the clinician (e.g., if the patient is obese), the clinician may elect to place the second hand inside the vagina and apply an upwardly directed pressure to compress the uterus. The frequency and intensity of the uterine massage (e.g., several times per hour in the first few postpartum hours) may depend on the severity of blood loss. A greater volume of blood lost may indicate improper uterine contraction. In some cases, the severity of the hemorrhage can be quantified by the volume of blood loss. For example, the loss of 500 mL of blood after delivery may be considered an indicator of postpartum hemorrhage. The hemorrhaging associated with slow or improper uterine contraction may result in hypotension (e.g., lightheadedness or dizziness), anemia, and fatigue, and, in some severe cases, may require surgical intervention.

Thus, the inventors have recognized that the manual nature of the conventional atonic uterine massages may create a significant time and effort burden on the clinicians responsible for the massage. Furthermore, proper uterine massages require skill to avoid other postpartum complications. The inventors have also recognized a lack of standardized systems for closely monitoring postpartum blood loss, which may cause a late or improper diagnosis of the patient's hemorrhage condition.

Based on the foregoing, the inventors have recognized the benefits associated with a postpartum massaging system which may automatically perform the uterine massage with less physical input needed from the clinician. The clinician may therefore be relieved of the physically taxing and time-intensive duties of the uterine massage. The massaging system may be designed to perform the massage at prescribed intervals and with varying degrees of intensity based on the condition of the patient. The system may also include an ability to measure the volume of blood flow from the uterus after delivery. In this way, the clinician may more accurately determine a hemorrhage state and act to avoid severe postpartum complications.

In some embodiments, a postpartum massaging system may include a uterine massaging belt. The belt may be worn on an external portion of a postpartum patient's abdomen, proximal to the uterus, such that it may urge the uterus to contract. In some embodiments, the massaging belt may include one or more rollers positioned near at least a portion of the uterus, e.g., the uterine fundus (i.e., an upper portion of the uterus proximal to the chest). The one or more rollers may be configured to apply pressure in an inferior direction (e.g., towards the patient's feet if the patient is lying flat). The massaging belt may also include an inflatable or expanding bladder configured to apply pressure in a superior direction (e.g., towards the patient's head if the patient is lying flat). In this way, at least a portion of the uterus may be compressed between the rollers and the bladder. This compressive force may serve to induce uterine contraction and reduce the risk of postpartum hemorrhage.

The inventors have recognized that having the inflatable bladder on the belt may be potentially less effective for patients with excessive tissue or fat near the lower abdomen region. As such, in some embodiments of the massaging belts described herein, instead of being integrated into a massage belt, the inflatable bladder may instead take the form of an inflatable balloon positioned within the vagina of the patient. The vaginal balloon may be used in combination with a massage belt with rollers configured to push the uterine fundus downwards on the patient. Accordingly, the combination of the vaginal balloon and the massage belt may compress the uterus between the vaginal balloon and the massage belt and induce contraction for improved postpartum outcomes.

In some embodiments, the massaging belt may be used in conjunction with a metered bag for collecting and monitoring the blood loss of the patient. The metered bag may be fluidically connected to the vagina of the patient, such that all blood loss from the uterus may be accounted for in the metered bag. The bag may therefore serve as an accurate reading of the uterine blood loss. The clinician may use this reading to determine the course of the uterine massage (e.g., reduce interval/intensity). The metered bag may be placed in fluid communication with the vagina using any fluid handling means. For example, the metered bag may be fluidically connected to a tube which may be partially sealed to the vagina. As such, a majority of blood flowing from the uterus may flow into the metered bag, allowing the clinician to have a more accurate reading of the patient's blood loss.

As will be described in greater detail below, the massaging belt may include one or more controllers for controlling the timing and intensity of the massage belt. It should be appreciated that the timing and intensity (and/or any other suitable operational parameters of the belt) may be determined by clinicians and/or clinically relevant standards. As such, the present disclosure is not limited by the interval timing or intensity of the various moving parts of the belt.

In some embodiments, the massaging belt may be configured to be worn over clothing or a hospital gown. In other embodiments, the massaging belt may be configured to be worn in direct contact with a patient's abdomen. Accordingly, the portions of the belt in contact with skin may be formed of a soft and comfortable material (to reduce the risk of irritating the patient's skin) which may not react with the skin or otherwise cause discomfort to the patient. For example, portions of the belt's band may be formed of a soft woven fabric, such as cotton or nylon.

The various portions of the uterine massage belts described herein may be formed of a comfortable and long-lasting material or combination of materials suitable for their respective function. For example, the optional vaginal balloon of some uterine massage systems may include an elastic silicone material compatible with the vaginal environment. The belt may be formed of any suitable material(s) which may withstand multiple activation cycles without degradation in properties or quality. In some instances, the belt may be re-usable between patients. As such, the belt may include one or more machine-washable components (e.g., straps) for hygienic reasons. The belt may also include one or more surfaces which may be readily cleaned without risk of damaging the underlying infrastructure. For example, one or more rollers and/or bladders may be formed of a silicone material. It should be appreciated that any suitable material known in the art may be employed for any suitable component (e.g., band, rollers, bladder) of the massaging belts of the present disclosure.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

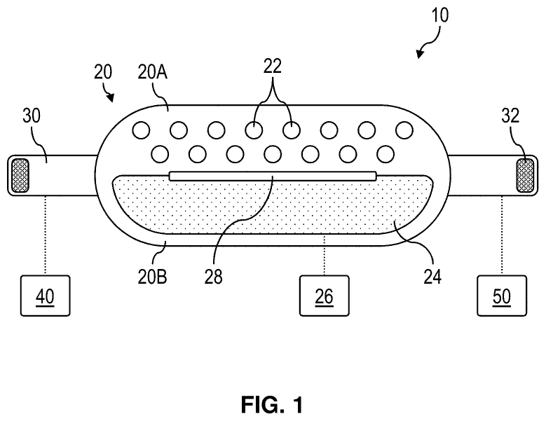

FIG. 1 shows a uterine massage belt 10 according to some embodiments. The belt 10 may include a ventral portion 20 configured to be placed on the patient's abdominal region (e.g., proximal to the uterus) and a band 30 to secure the ventral portion on the patient. The ventral portion 20 may be positioned central to the belt 10. The band 30 may be wrapped around the patient's abdomen and may be adjustable to comfortably suit the patient's abdomen size. The band 30 may be secured to the patient using one or more fasteners 32, which can be any suitable arrangement, including, but not limited to, straps, buttons, hook and eye closures, connectors, tapes, adhesives, buckles (e.g., quick release buckle clips), and/or other interlocking fasteners, such as hook and loop fasteners. The band may be formed of any suitable flexible material (e.g., a woven fabric, an elastic textile, etc.) known in the art, as the present disclosure is not limited by the material composition or arrangement of the band.

As shown in FIG. 1, the ventral portion 20 may include one or more rollers 22 and at least one bladder 24. The rollers 22 may be positioned on an upper portion 20A of the belt 10. In some embodiments, the rollers 22 may be positioned to interface with the fundal portion of the uterus. In some embodiments, the rollers 22 may roll in a downward position towards the bladder 24. Of course, the rollers 22 may roll in any suitable direction to apply pressure to at least a portion of the uterus (e.g., to the fundal portion of the uterus) towards the vagina. For example, the rollers may roll in an inferior direction about an axis orthogonal to the superior-inferior axis of the patient. It should be appreciated that although fifteen equally-sized and spaced rollers 22 are shown in FIG. 1, any suitable number of rollers, in any suitable arrangement, with any suitable variation in size and/or type may be employed as the present disclosure is not so limited.

The bladder 24 may be positioned on a lower portion 20B of the belt 10. In some embodiments, the bladder 24 may be positioned to interface with the lower portion of the uterus, proximal to the vagina. In some embodiments, the bladder 24 may be inflated or otherwise actuated or expanded to apply a constant pressure to the lower portion of the uterus. Based on the configuration of the belt 10 on the patient's abdomen, the inflation of the bladder 24 may result in a generally upward directed force on the uterus. In this way, the uterus may be compressed in between the bladder 24 and downward rolling rollers 22. It should be appreciated that although a single bladder 24 is shown in FIG. 1, embodiments in which more than one bladder are employed are also contemplated. For example, a uterine massage belt may include at least one bladder positioned centrally on the patient's abdomen, and one or more lateral bladders positioned on the side of the central bladder to further apply pressure to the uterus in a medial direction.

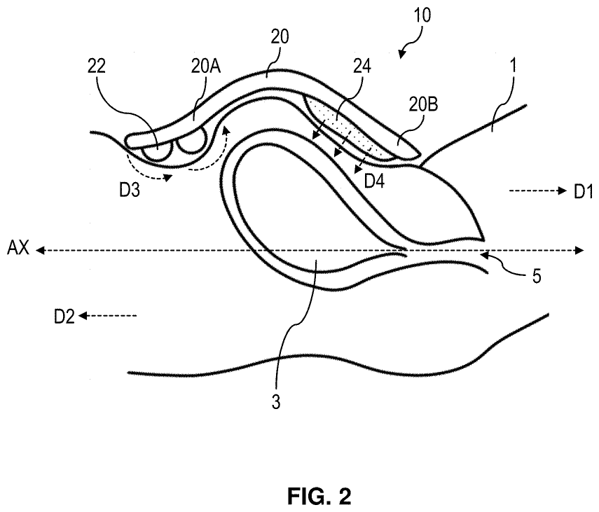

FIG. 2 shows a partial cross-section of a uterine massage belt 10 installed on a patient 1. The band of the massage belt has been omitted in this figure for clarity. In some embodiments, the belt 10 may include one or more rollers 22 positioned on an upper portion 20A of a ventral portion 20 of the belt. The rollers 22 may be configured to move in a generally inferior direction D1 (see for example, rolling direction D3), to apply an inferiorly-directed (e.g., towards the vagina 5) pressure to the uterus 3. The belt 10 may also include at least one bladder 24 positioned on a lower portion 20B of the ventral portion. The belt may apply pressure to the uterus 3 in a generally superior direction D2 (see for example, compression direction D4). In this way, the uterine massage belt actively compresses the uterus 3 in between the rollers 22 and bladder 24. It should be appreciated that although there is a component of the forces applied by the rollers and bladder that is directed dorsally in FIG. 2, there is also a component of the forces that is directed along the patient's superior-inferior axis AX. In some embodiments, the majority of the forces may be directed along the patient's superior-inferior axis AX.

The rollers of the present disclosure may apply any suitable active force to the uterus. In some embodiments, the rollers could rotate about an axis orthogonal to the superior-inferior axis AX of the patient. In some embodiments, the rollers could rotate about an axis as well as translate about another axis relative to the patient, such that they may apply a kneading or massaging force to the patient. It should be appreciated that any suitable force, combination of forces (e.g., various magnitudes and directions), and/or types of force may be employed in the uterine massage belts of the present disclosure.

As used herein, the term “upper portion” may refer to the portion of the massage belt configured to be positioned proximal to the uterine fundus. The term “lower portion” may refer to the portion of the massage belt configured to be positioned proximal to the pubic bone, and positioned below the upper portion. The term “upper” may generally refer to a direction towards the head of the patient, whereas the term “lower” may generally refer to a direction towards the feet of the patient.

In some embodiments, the bladder of a uterine massage belt may be positioned on an upper portion of a uterine massage belt and the rollers may be positioned on a lower portion of the uterine massage belt. In other words, the position of the active components of the uterine massage belt may be reversed. The uterus may still be compressed between the components. In some embodiments, at least one bladder on the upper portion and at least one bladder on the lower portion of the uterine massage belt may be employed. In other embodiments, a set of rollers on the upper portion and a set of rollers on the lower portion of the uterine massage belt may be employed. Accordingly, the uterine massage belts of the present disclosure are not limited by the arrangement of the bladder and rollers.

Turning back to FIG. 1, in some embodiments, the bladder 24 may be in fluid communication with a fluid source 26, such that it may be inflated with fluid from the fluid source to expand and apply pressure to the patient's abdomen/uterus. The fluid source may be a port connected to ambient air and a hand pump. The patient and/or clinician may squeeze the hand pump to force air from the ambient environment into the bladder 24. In some embodiments, the pump may be automatically controlled with one or more power sources 50, such that they may actively drive fluid into the bladder 24. In other embodiments, the fluid source may be a non-air fluid container and associated pump for inflating or otherwise expanding the bladder 24. It should be appreciated that the present disclosure is not limited by the mechanism and infrastructure with which the bladder 24 is inflated.

In some embodiments, the massage belt 10 may optionally include one or more sensors 28 to measure the stiffness or tension within the uterus. In some embodiments, the sensors 28 may apply a dorsally directed force toward the uterus and measure the reaction force to determine one or more mechanical properties of the uterus. For example, in some embodiments, the belt may include a pressure-sensitive probe which may probe the region of the abdomen and/or pelvis overlying the uterus and determine whether the uterus is gaining tone. Although a single elongated sensor 28 is shown in FIG. 1, the massage belts of the present disclosure may have any suitable type (e.g., strain, force, capacitive), shape, and/or number of sensors, arranged in any suitable position relative to the rollers 22 or bladder 24. In some embodiments, the belt may be used with a sensor that makes direct contact with the uterus (e.g., is inserted trans-vaginally to contact the uterus directly).

In some embodiments, the sensors 28 may communicate with one or more processors 40, which may subsequently process said data. For example, the processors may determine changes in mechanical properties over time by comparing and tracking subsequent measurements. If a tonic uterine stiffness (or any other suitable property) is measured, the processor may communicate with the patient and/or clinician to notify them of the successful results of the massage belt. For example, if the processors 40 determined an increasingly tonic or strengthened uterus from the data collected by the sensors 28, the processor may communicate this information to the clinician.

In some embodiments, the massage belt 10 may include a power source 50. The power source 50 may drive the rollers 22 to roll (e.g., rotate about an axis) and activate the bladder 24 by inflation (e.g., by driving a fluid into the bladder) or other modes of expansion. The power source 50 may be portable (e.g., a battery pack) and/or may require an outlet, such that it may only be used in particular settings (e.g., in a hospital bed). In some embodiments, the power source 50 may include one or more controllers which may control the timing of the belt's activity. For example, the controllers may activate the rollers and bladder at 10-minute intervals for several hours following delivery. In some embodiments, the power source 50 and its optional controllers may be in communication with the sensors 28 and the processors 40 to allow the massage belt to operate generally hands-free. In some embodiments, the massage belt may optionally include one or more interfaces for communicating the status of the belt to the patient and/or clinician. For example, the belt may include flashing lights to indicate the various procedures (e.g., activate, measure stiffness, de-activate) of the belt. It should be appreciated that the present disclosure is not limited by the type, number, arrangement, and/or any other suitable parameter of the processors, controllers, power sources, and/or sensors.

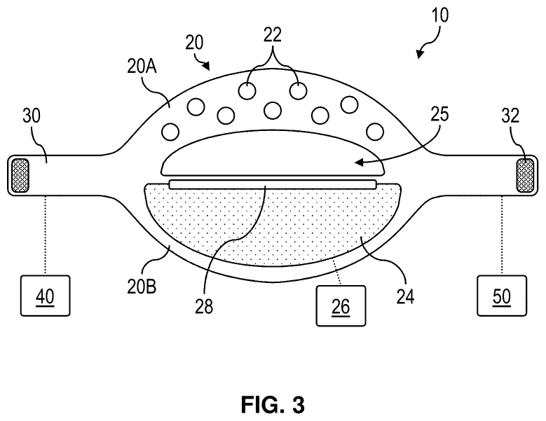

FIG. 3 shows a uterine massage belt 10 according to some embodiments. The belt 10 may include rollers 22 and at least one bladder 24, similar to the belt shown in FIG. 1. In embodiments represented by FIG. 3, the belt 10 may include a segmented ventral portion 20, including an upper portion 20A and a lower portion 20B. When the belt 10 is suitably worn, the upper portion 20A may be placed against the uterine fundus and the lower portion 20B may be placed against the pubic bone. As such, the uterus may be compressed in between the rollers 22 and inflatable bladder 24.

As shown in FIG. 3, the belt 10 may include a gap 25 in between the upper 20A and lower 20B portions of the ventral portion 20, according to some embodiments. The gap 25 may serve to de-couple the movement of the rollers 22 and bladder 24, and provide more room in between the two portions to help with compression of the uterus between the rollers and the bladder. As noted previously, in the active state of the massage belt, the rollers 22 and bladder 24 may apply pressure to the uterus in opposing directions. The rollers 22 may be rolling in the inferior direction towards the patient's feet and the bladder 24 may be pushing the patient's abdomen in a generally superior direction towards the patient's head. As such, a gap 25 in between the two sections of the belt may allow each feature to operate independently, limiting the amount of crosstalk between the rollers and the bladder.

In some instances, a portion of the patient's abdomen (e.g., excess skin or tissue) located near the gap 25 may be uncompressed by the belt 10, such that the patient may be more comfortable. In some embodiments, the gap 25 may be covered with a flexible material (e.g., a soft textile) to allow a portion of the patient's abdomen to protrude from the belt without significant push back from the belt.

It should be appreciated that the gap may be positioned anywhere on the belt relative to the rollers and bladder, as the present disclosure is not limited by the arrangement of any feature of the belt.

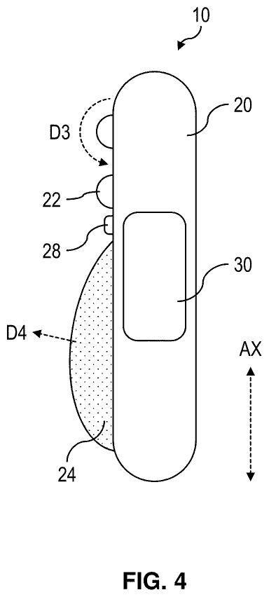

FIG. 4 shows a side view of a massage belt 10 according to some embodiments. This view illustrated the motion of one or more rollers 22 and bladder 24 positioned in a ventral portion 20 of the belt 10. As shown in the figure, when the belt 10 is activated, the rollers 22 may roll in a direction D3 to help push the uterine fundus towards the bladder 24. Simultaneously, or concurrently, the bladder 24 may be inflated in direction D4, pushing the lower portion of the uterus (near the pubic bone) up towards the fundus. With this combination of movements, the uterus may be compressed in between the rollers 22 and bladder 24. It should be appreciated that although direction D4 is shown to have a dorsal component (e.g., pressing the abdomen in a dorsal direction), the bladder 24 may be configured to firmly press the uterus in a superior direction (e.g., towards the patient's head). The movement of rollers 22 and bladder 24 depicted in FIG. 4 may also apply to the massage belt embodiments represented by FIGS. 2 and 3.

FIG. 4 also depicts a superior-inferior axis AX of the patient relative to the belt 10. As such, as shown in the figure, the rollers 22 may be offset from the bladder 24 along this superior-inferior axis AX. In this way, the uterus may be compressed in between the bladder and the rollers to induce uterine contraction.

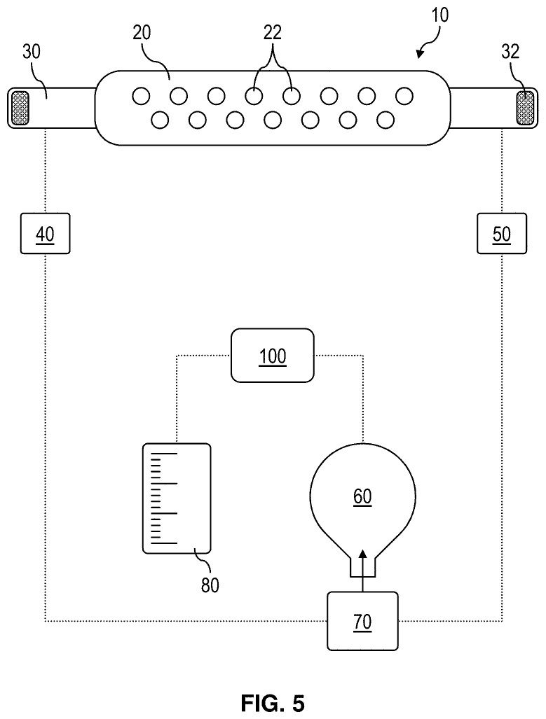

FIG. 5 depicts an embodiment of a massage belt and balloon combination which may be employed for obese patients, or for patients for whom the lower abdomen may be inaccessible. In some embodiments, a massage belt 10 may include a ventral portion 20 with one or more rollers 22. The rollers 22 may serve a similar function to the rollers previously described with respect to FIGS. 2-3, to apply a pressure toward the uterus in an inferior direction. The bladders of FIGS. 2-3 may be replaced with a vaginal balloon 60, shown in FIG. 5. The vaginal balloon may be inserted at least partially inside the vagina 100 of a patient such that it may exert a force in the superior direction (e.g., towards the patient's head) upon inflation to compress the uterus against the rollers 22.

The balloon 60 may be inflated with a fluid source 70 including a pump (either manual or automatic). In some embodiments, the inflation of the balloon 60 and operation of associated pumps (if automatic) may be controlled with one or more controllers of a power source 50. The controllers may sync the movements of the rollers 22 and balloon 60, such that the uterus may be compressed between the inferiorly directed (downward) motion of the rollers and the superiorly directed (upward) pressure of the balloon 60 during activation of the belt.

As described previously, in any embodiment of the uterine massage belt of FIGS. 2-5, the belt may be used in addition to a metered bag (see for example, bag 80 in FIG. 5) fluidically connected to the vagina (see for example, vagina 100 in FIG. 5). In this way, the metered bag may collect blood flow out of the vagina, allowing the clinician to monitor the volume of expelled blood. In some embodiments, the volume of collected blood flow may be measured at intervals associated with the activation of the belt, such that the effect of the massage belt may be monitored and tracked over time. The metered bag may include one or more sensors in communication with the processors and/or controllers of the massage belt, such that the activation of the belt may be adjusted based on the volume of blood flow. For example, if less blood is collected after a certain number of activation cycles of the belt, the controllers may gently reduce the frequency or duration of the activation cycles, as the uterus may be gradually contracting and may need less assistance from the belt. It should be appreciated that any suitable metered bag infrastructure known in the art may be employed to monitor blood loss, as the present disclosure is not so limited.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

Any terms as used herein related to shape, orientation, alignment, and/or geometric relationship of or between, for example, one or more articles, structures, forces, fields, flows, directions/trajectories, and/or subcomponents thereof and/or combinations thereof and/or any other tangible or intangible elements not listed above amenable to characterization by such terms, unless otherwise defined or indicated, shall be understood to not require absolute conformance to a mathematical definition of such term, but, rather, shall be understood to indicate conformance to the mathematical definition of such term to the extent possible for the subject matter so characterized as would be understood by one skilled in the art most closely related to such subject matter.

1. A uterine massage belt comprising:
a band comprising a central portion;
at least one roller configured to be positioned on a first portion of the central portion of the band; and
at least one inflatable bladder configured to be positioned on a second portion of the central portion of the band,
wherein the at least one roller and the at least one inflatable bladder are configured to compress at least a portion of a uterus of a patient between the at least one roller and the at least one inflatable bladder to induce uterine contraction.

2. The uterine massage belt of claim 1, wherein the at least one roller and the at least one inflatable bladder are positioned offset from one another on the central portion of the band.

3. The uterine massage belt of claim 1, wherein the band is configured to wrap around an abdomen of the patient.

4. The uterine massage belt of claim 1, wherein the at least one roller is configured to be positioned proximal to a uterine fundus of the patient, and wherein the at least one roller is configured to apply a first force in an inferior direction of the patient.

5. The uterine massage belt of claim 1, wherein the at least one inflatable bladder is configured to be positioned proximal to a pubic bone of the patient, and wherein the at least one inflatable bladder is configured to apply a second force in a superior direction of the patient.

6. The uterine massage belt of claim 1, wherein the at least one roller is configured to apply a first force on a uterine fundus of a patient concurrently with the at least one inflatable bladder configured to apply a second force on a pubic bone of the patient.

7. The uterine massage belt of claim 1, wherein with the band worn on the patient, the at least one roller is configured to apply a first force toward the at least one inflatable bladder, wherein the at least one inflatable bladder is configured to be inflated to apply a second force toward the at least one roller.

8. The uterine massage belt of claim 1, wherein the at least one roller comprises a plurality of rollers.

9. The uterine massage belt of claim 1, further comprising at least one sensor configured to measure at least one mechanical property of the portion of the uterus of the patient.

10. The uterine massage belt of claim 9, further comprising at least one processor in communication with the at least one sensor, wherein the at least one processor is configured to track the at least one mechanical property over time.

11. A system comprising the uterine massage belt of claim 1, further comprising:
a metered bag configured to be placed in fluid communication with a vagina of the patient,
wherein the metered bag is configured to collect blood from the vagina.

12. A system for uterine massage comprising:
a band comprising a central portion;
at least one roller disposed on the central portion of the band; and
an inflatable vaginal balloon configured to be inserted into a vagina of a patient,
wherein the at least one roller is configured to apply a first force toward the inflatable vaginal balloon, and wherein the inflatable vaginal balloon is configured to apply a second force toward the at least one roller.

13. The system of claim 12, wherein the band is configured to wrap around an abdomen of the patient.

14. The system of claim 12, wherein the at least one roller is configured to be positioned proximal to a uterus of the patient, and wherein the at least one roller is configured to apply the first force in an inferior direction of the patient.

15. The system of claim 12, wherein the inflatable vaginal balloon is configured to apply the second force in a superior direction of the patient.

16. The system of claim 12, further comprising a metered bag configured to be placed in fluid communication with the vagina of the patient, wherein the metered bag is configured to collect blood from the vagina.

17. The system of claim 12, wherein the at least one roller and the inflatable vaginal balloon are configured to compress at least a portion of a uterus of the patient between the at least one roller and the inflatable vaginal balloon to induce uterine contraction.

18. The system of claim 12, further comprising at least one sensor configured to measure at least one mechanical property of a portion of a uterus of the patient.

19. The system of claim 18, further comprising at least one processor in communication with the at least one sensor, wherein the at least one processor is configured to track the at least one mechanical property over time.

20. A method of providing uterine massage, comprising:
actuating at least one roller to apply a first force toward a uterus of a patient;
inflating at least one bladder to apply a second force toward the uterus of the patient; and
compressing at least a portion of the uterus in between the at least one roller and the at least one bladder during actuation of the at least one roller to induce uterine contraction.

21-33. (canceled)
